(19) United States
(12) Patent Application Publication
(10) Pub. No.: US 2021/0126937 A1
(43) Pub. Date: Apr. 29, 2021

(54) CYBER-SECURITY IMPROVEMENT PLATFORM UTILIZING A SECURE, DISTRIBUTED TRANSACTION LEDGER

(71) Applicant: General Electric Company, Schenectady, NY (US)

(72) Inventors: Austars Raymond Schnore, JR., Scotia, NY (US); Safayet Nizam Uddin AHMED, Niskayuna, NY (US); David Safford, Cliffton Park, NY (US); Krzysztof KEPA, Niskayuna, NY (US); Willard Monten WISEMAN, Amsterdam, NY (US); Kevin B. KENNY, Niskayuna, NY (US); William David SMITH, III, Schenectady, NY (US); Masako YAMADA, Niskayuna, NY (US)

(21) Appl. No.: 16/665,678

(22) Filed: Oct. 28, 2019

(51) Int. Cl. H04L 29/06; H04L 9/06; G06F 16/23; G06Q 20/36

(52) U.S. Cl. CPC H04L 63/1433; H04L 9/0637; G06F 16/2365; G06Q 2220/00; H04L 2209/38; H04L 2209/56; G06Q 20/3678

(57) ABSTRACT

A cyber-security improvement platform database may store electronic records including information, received from remote submitting devices, associated with vulnerability data for computing elements. Information associated with first vulnerability data for a first computing element may be retrieved from the database and verified. Information about the first vulnerability data may then be recorded in a secure, distributed transaction ledger, and a crypto-currency payment may be transferred in connection with the recorded information. Similarly, the electronic records may further include fix data for computing elements. In this case, first fix data associated with the first vulnerability data may be retrieved, verified, and applied in connection with the first computing element. Additional information, about the first fix data, may then be recorded in the transaction ledger and an additional crypto-currency payment may be transferred in connection with the recorded additional information.

### BACKGROUND

Some embodiments disclosed herein relate to computing elements and, more particularly, to cyber-security improvement platform that utilizes a secure, distributed transaction ledger.

A computing element (e.g., a cloud-based software application or an industrial control system) may be the subject of a cyber-attack. For example, the computing element might encounter a computer virus, worm, Trojan horse, etc. Such attacks may cause significant financial damage, release personal information, shut down the operation of a factory or business, etc. These types of attacks are often the result of unintentional vulnerabilities found in software code, Operating System (“OS”) files, etc. but identifying such vulnerabilities can be a time consuming and expensive task. Moreover, even after a vulnerability is identified, the creation of a fix to improve the cyber-security of the computing element can also be a difficult job (e.g., especially when there are a substantial number of identified vulnerabilities and/or the computing elements are unusually complete) and manually performing these functions may be impractical and inefficient. It would therefore be desirable to provide systems and methods to efficiently arrange cyber-security improvements for computing elements.

### SUMMARY

Some embodiments provide a system to facilitate cyber-security improvements. A cyber-security improvement platform database may store electronic records including information, received from remote submitting devices, associated with vulnerability data for computing elements. Information associated with first vulnerability data for a first computing element may be retrieved from the database and verified. Information about the first vulnerability data may then be recorded in a secure, distributed transaction ledger, and a crypto-currency payment may be transferred in connection with the recorded information. Similarly, the electronic records may further include fix data for computing elements. In this case, first fix data associated with the first vulnerability data may be retrieved, verified, and applied in connection with the first computing element. Additional information, about the first fix data, may then be recorded in the transaction ledger and an additional crypto-currency payment may be transferred in connection with the recorded additional information.

Some embodiments comprise: means for retrieving, from a cyber-security improvement platform database, first fix data associated with a first computing element, wherein the cyber-security improvement platform database stores electronic records including information, received from remote submitting devices, associated with fix data for computing elements; means for verifying the first fix data; means for arranging for the first fix data to be applied in connection with the first computing element; and means for recording information about the first fix data in the secure, distributed transaction ledger, wherein a crypto-currency payment is transferred in connection with the recorded information.

Some embodiments comprise means for retrieving, by a cyber-security improvement platform computer processor, information associated with first vulnerability data associated with the first fix data from a cyber-security improvement platform database; means for verifying the first vulnerability data; and means for recording additional information about the first vulnerability data in the secure, distributed transaction ledger, wherein an additional crypto-currency payment is transferred in connection with the recorded additional information.

Technical effects of some embodiments of the invention are improved ways to efficiently arrange cyber-security improvements for computing elements. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of computing elements that might experience a cyber-attack.

FIG. 2 is a high-level block diagram of a system according to some embodiments.

FIG. 3 is a method that may be associated with cyber-security improvements in accordance with some embodiments.

FIG. 4 is another cyber-security improvement system in accordance with some embodiments.

FIG. 5 is a system implementing blockchain enabled cyber-security improvements with blockchain validation according to some embodiments.

FIG. 6 is a system implementing blockchain enabled cyber-security improvements with multiple cyber-security improvement platforms in accordance with some embodiments.

FIG. 7 is a software security blockchain consensus protocol display according to some embodiments.

FIG. 8 illustrates cyber-security improvement nodes in accordance with some embodiments.

FIG. 9 illustrates a platform according to some embodiments.

FIG. 10 is a portion of a tabular computing element database in accordance with some embodiments.

FIG. 11 is a distributed transaction ledger reference architecture according to some embodiments.

FIG. 12 illustrates a tablet computer providing a display according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

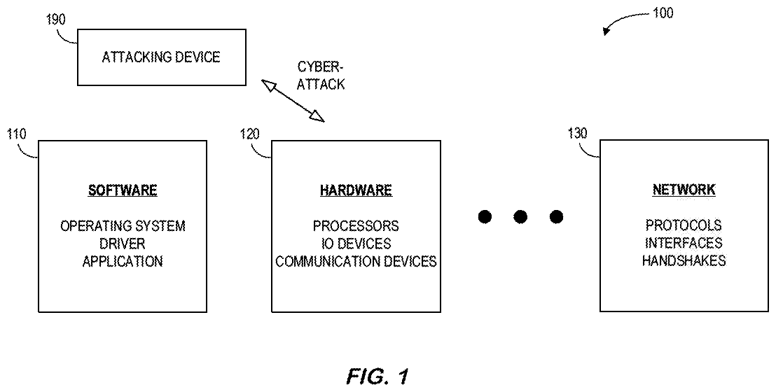

It may generally be desirable to efficiently arrange cyber-security improvements for computing elements. FIG. 1 is a high-level block diagram 100 of computing elements that might experience a cyber-attack (e.g., from an attacking device 190 such as a remote computer). As used herein, the phrase “computing element” might be associated with, for example, a software element 110 (e.g., an OS, drive, or application), a hardware element 120 software element 110 (e.g., a processor, an Input Output (“IO”) device, or a communication device), a network element software element 110 (e.g., a protocol, an interface, or a handshake), etc.

Some embodiments described herein may improve cyber-security using a secure, distributed transaction ledger (e.g., blockchain)—but not in the traditional way of securing events and data in the chain. Instead, some embodiments use the incentive of a crypto-currency that is based on improving the cyber-security quality software and associated infrastructure. For example, blockchain and crypto-currency technologies may be brought together with the security community to form a new crypto-currency that not only secures transactions but may also improve the cyber-security stance of existing software infrastructure. To accomplish this, a new crypto-currency may be built on distributed ledger technology and replace the typical class of “Proof of Work” consensus algorithms used by other currencies with an algorithm that incentivizes reduction of software vulnerabilities.

Note that BITCOIN® and other public blockchains have become popular because they offer alternative approaches to securing transactions. Moreover, this can be accomplished in a decentralized manner (and with varying levels of autonomy). BITCOIN® in particular has gained a lot of attention because of the way it incentives the securing of its distributed ledger through the use of what is called a Bitcoin. A Bitcoin is a financial instrument or crypto-currency that has a value that (like other currencies) may rise or fall in value. A Bitcoin can be purchased like many currencies or it can be earned by what is called “mining.” The result of this mining is the execution of a consensus algorithm that guards against three types of attack that might assail the distributed ledger. The first protection it provides is Byzantine Fault Tolerance (where some number of nodes in the distributed ledger network go rogue and try to modify the ledger in a way that doesn't reflect the transactions that have been legitimately applied). Second, mining lets any node participate (and no identity required). Third, mining provides a means to protect against spam or denial of service attacks. This type of approach is referred to as a Proof of Work consensus algorithm (although in the case of Bitcoin the algorithm is computationally difficult, but the results aren't useful for any other purpose). In fact, there are other approaches which are not nearly as wasteful and are computationally more efficient at securing the distributed ledger (but don't necessarily prevent spamming and denial of service attack protection as effectively). Some embodiments described herein offer protection and get useful, reusable work from a similar system.

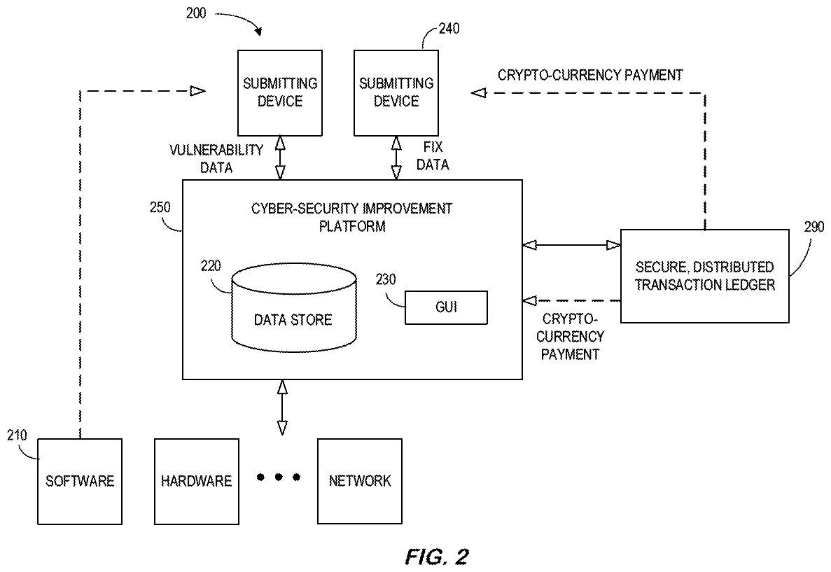

Improving cyber-security for computational systems is a complex topic and there is a need for methods to identify software vulnerabilities quickly, patch or “fix” them, and verify those patches. Doing this, however, can be a difficult and thankless job. Researchers spend a lot of time looking for these vulnerabilities but don't get much reward for this effort. Embodiments described herein may incentivize more people to look for such improvements (and to verify and fix any vulnerabilities that are discovered). For example, the cyber-security improvement system 200 of FIG. 2 includes a cyber-security improvement platform 250 with a communication port to exchange information with computing elements 210 (e.g., software, hardware, network, etc.) and/or a remote secure, distributed transaction ledger 290. The cyber-security improvement platform 250 may also exchange information with remote submitting devices 240 (e.g., to receive information about vulnerability data and/or fix data for the computing elements 210).

The cyber security improvement platform 250 may access information in a data store 220 and/or facilitate the provisional of displays via a Graphical User Interface (“GUI”) 230. The data store 220 might include, for example, electronic data records associated with computing elements 210, including software code, operating specification, circuit designs, etc. By way of an example only, the cyber-security improvement platform 250 might be associated with an application developer, an industry committee, etc.

According to some embodiments, the cyber-security improvement platform 250 records vulnerability and fix data in the secure, distributed transaction ledger 290. For example, the cyber-security improvement platform 250 might record a security flaw or bug, a patch to address a known security problem, or the like via the secure, distributed transaction ledger 290 in accordance with any of the embodiments described herein. The transaction ledger 290 might be associated with, for example, blockchain technology that can be verified via a remote operator or administrator device. According to some embodiments, the distributed transaction ledger might be associated with the HYPERLEDGER® blockchain verification system. According to some embodiments, the transaction ledger 290 may also facilitate cyber-currency payments to submitting devices 240 and/or the improvement platform 250 in exchange for their service.

Note that the platform 250 could be completely de-centralized and/or might be associated with a third party, such as a vendor that performs a service for an enterprise. According to some embodiments, submitting devices 240 might directly access the computing elements 210 to look for problems (as illustrated by the dotted arrow in FIG. 2).

The cyber-security improvement platform 250 and/or submitting devices 240 might be, for example, associated with a Personal Computer (“PC”), laptop computer, a tablet computer, a smartphone, an enterprise server, a server farm, and/or a database or other storage devices. According to some embodiments, an “automated” cyber-security improvement platform 250 may automatically record vulnerability and fix information in the transaction ledger 290 via a blockchain verification process. As used herein, the term “automated” may refer to, for example, actions that can be performed with little (or no) intervention by a human.

As used herein, devices, including those associated with the cyber-security improvement platform 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The platform 250 may store information into and/or retrieve information from data stores. The data stores might, for example, store electronic records representing prior transactions, transactions currently in process, digital events, etc. The data stores may be locally stored or reside remote from the platform 250. Although a single cyber-security improvement platform 250 and secure, distributed transaction ledger 290 are shown in FIG. 2, any number of such devices may be included. Moreover, various devices described herein might be combined according to embodiments of the present invention. For example, in some embodiments, the cyber-security improvement platform 250, secure, distributed transaction ledger 290, and/or other devices might be co-located and/or may comprise a single apparatus.

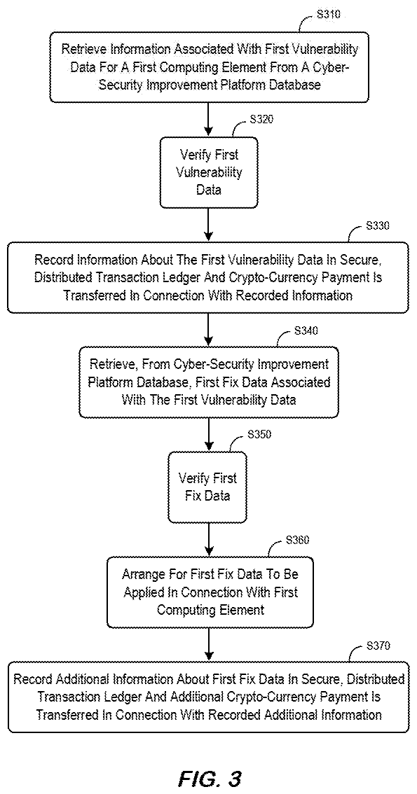

Note that the system 200 of FIG. 2 is provided only as an example, and embodiments may be associated with additional elements or components. According to some embodiments, the elements of the system 200 provide blockchain enabled cyber-security improvements for computing elements. For example, FIG. 3 illustrates a method that might be performed by the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a cyber-security improvement platform computer processor may retrieve information associated with first vulnerability data associated with a first computing element from a cyber-security improvement platform database. The first computing element might be associated with, for example, a software element, a hardware element, and a network element, etc. At S320, the first vulnerability data may be verified. For example, the system may determine that an application does, in fact, have the security flaw that was reported by a submitting device (e.g., via web portal).

At S330, the system may record information about the first vulnerability data in a secure, distributed transaction ledger (e.g., via blockchain). Note that the a blockchain ledger might be controlled by a single, centralized entity or by multiple, distributed entities. According to some embodiments, a crypto-currency payment is transferred in connection with the recorded additional information (e.g., a submitter may be rewarded for discovering a network vulnerability). Note that the information recorded in the secure, distributed transaction ledger may represent a Proof of Work algorithm.

At S340, the system may retrieve, from a cyber-security improvement platform database, first fix data associated with the first vulnerability and verify the first fix data at S350. For example, the system may verify that the proposed fix actually removes the cyber-security vulnerability. At S360, the system may arrange for the first fix data to be applied in connection with the first computing element (e.g., by releasing a patch or updated software version). At S370, the system recording information about the first fix data in the secure, distributed transaction ledger. Again, a crypto-currency payment may be transferred in connection with the recorded information (e.g., tor reward the person who authored the proposed fix). According to some embodiments, an entity associated with the cyber-security improvement platform also receives a crypto-currency payment (e.g., in exchange for facilitating the process).

According to some embodiments, the cyber-security improvement platform computer processor also performs a duplicate vulnerability data check and/or a duplicate fix data check (e.g., to avoid unnecessary re-work). In some cases, the cyber-security improvement platform computer processor automatically verifies the first fix data and in other cases it may use human assistance to verify the first fix data (and might utilze a consensus of a plurality of humans, such as a panel of experts). In either case, an evaluation of multiple fixes that all address a single vulnerability might be performed to select (and reward) the “best” fix. Similarly, human assistance might be utilized to verify the first vulnerability data.

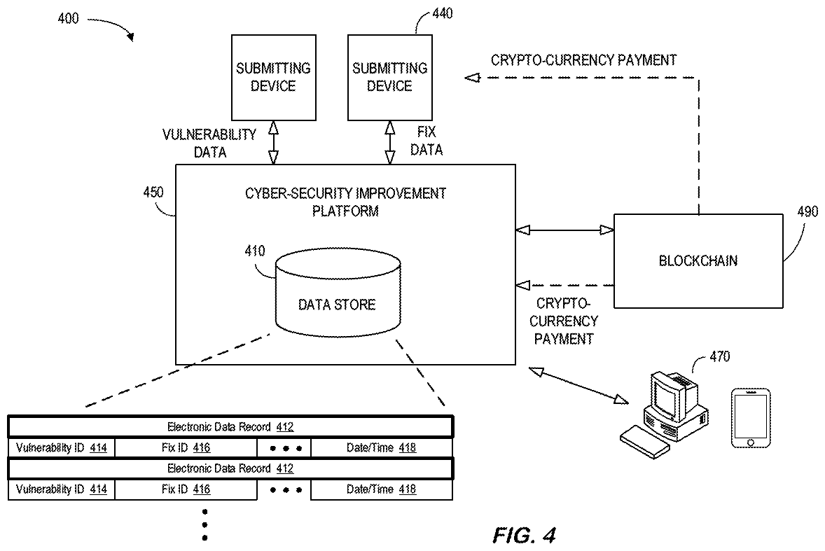

FIG. 4 is another cyber-security improvement system 400 in accordance with some embodiments. As before, a cyber-security improvement platform 450 may exchange information with a remote secure, distributed transaction ledger or blockchain 490. The cyber-security improvement platform 450 may also exchange information with remote submitting devices 440 (e.g., to receive information about vulnerability data and/or fix data for the computing elements 410). The cyber security improvement platform 450 may access information in a data store 420 and/or facilitate the provisional of displays via a GUI 430. The data store 420 might include, for example, electronic data records 412 associated with computing elements 410, including a vulnerability identifier 414, a fix identifier 416, a date and time 418, etc.

According to some embodiments, the cyber-security improvement platform 450 records vulnerability and fix data in the blockchain 490. For example, the cyber-security improvement platform 450 might record a security flaw or bug, a patch to address a known security problem, or the like via the blockchain 490 in accordance with any of the embodiments described herein. The cyber-security improvement platform 450 and/or blockchain 490 might be, for example, verified or adjusted via a remote operator or administrator device 470. According to some embodiments, the transaction ledger 490 may also facilitate cyber-currency payments to submitting devices 440 and/or the improvement platform 450 in exchange for their service.

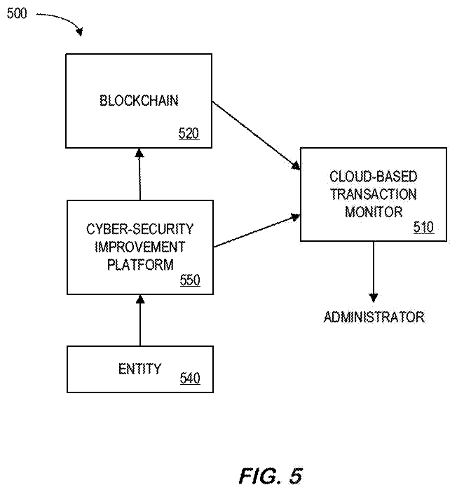

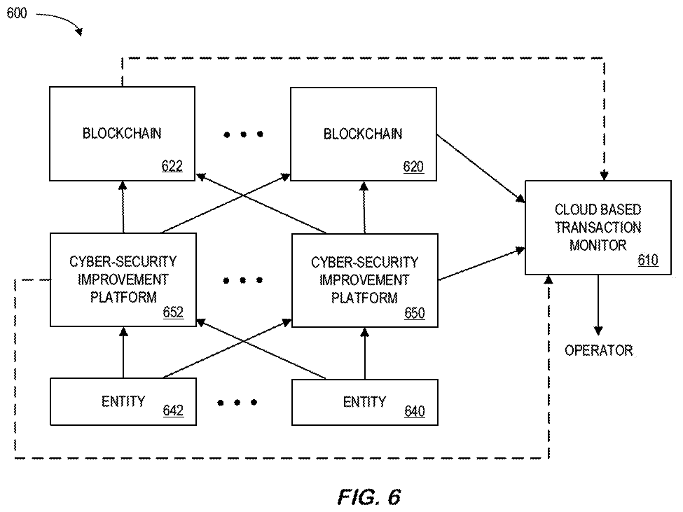

FIG. 5 is a system 500 implementing cyber-security improvements incorporating blockchain validation according to some embodiments. A cloud-based integrity monitor 510 may provide transaction integrity data via a web browser and exchange information with a blockchain 520 and a cyber-security improvement platform 550 via Representational State Transfer (“REST”) web services. The REST web services may, for example, provide interoperability between computer systems on the Internet (e.g., by allowing requesting systems to access and manipulate textual representations of web resources using a uniform, predefined set of stateless operations). According to some embodiments, portions of the cyber-security improvement platform 550 may be associated with a MySQL or Oracle® database. In this way, the cyber-security improvement platform 550 and blockchain 520 can be used to provide transaction level verification for an entity 540 (e.g., vulnerability or fix data). Although FIG. 5 illustrates a system 500 with a single blockchain 520 and cyber-security improvement platform 550, note that embodiments may employ other topologies. For example, FIG. 6 is a system 600 implementing cyber-security improvements incorporating multiple cyber-security improvement platforms 650, 652 in accordance with some embodiments. In particular, an additional blockchain 622 and cyber-security improvement platform 652 may provide protection for an additional entity 642. As illustrated in FIG. 6, each digital transaction engine 650, 652 may be associated with multiple blockchains 620, 622 providing additional protection for the system 600 (e.g., by storing information at multiple, geographically disperse nodes making cyber-attacks impractical). That is, each verifier (e.g., each cyber-security improvement platform 650, 652) may commit a brief summary to an independent data store and, once recorded, the information cannot be changed without detection to provide a tamper-proof System of Records (“SoR”).

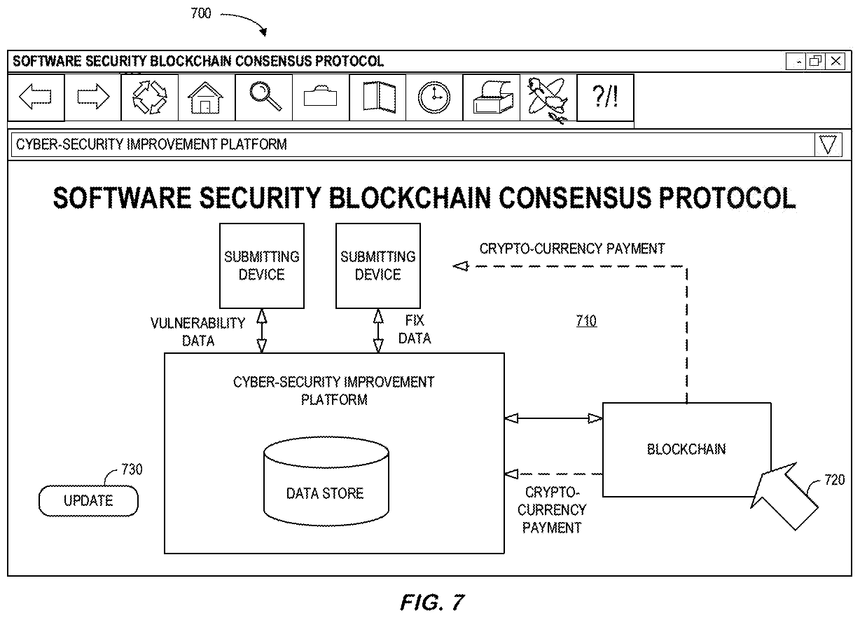

FIG. 7 illustrates a computer display 700 in accordance with some embodiments. The display 700 includes a graphical representation 710 of a cyber-security improvement system such that a user may select elements of the system (e.g., via a computer mouse pointer 720 or touchscreen) to see further information and/or adjust details about that element (e.g., via a pop-up window). According to some embodiments, the display 700 includes one or more selectable icons 720 that can be used to update security or computing element information, export or import data, save files, publish information, perform a blockchain validation, etc.

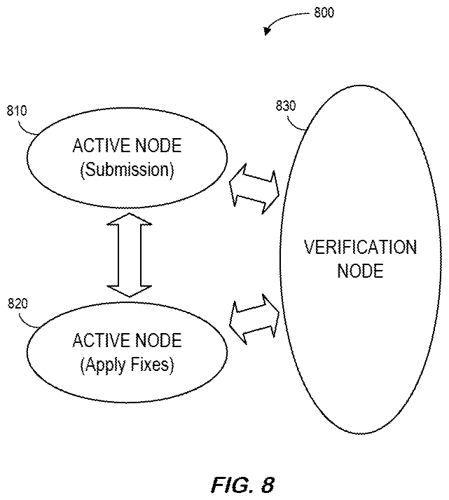

FIG. 8 illustrates 800 cyber-security improvement nodes in accordance with some embodiments. As in other blockchains, distributed nodes may store a ledger as well as act as validators, witnesses, miners, etc. The miners might come in three forms, with the first being an active node 810 that may submit discoveries of new, unrecorded vulnerabilities. The second type of node might be active as well but may see vulnerabilities and apply fixes 820 to computing elements. The third may be a predominate node that would verify the vulnerability 830 and the applied fixes. Each type of node 810, 820, 830 might be associated with a different payout for their contribution (and the result of all of their efforts may be used to secure a distributed ledger).

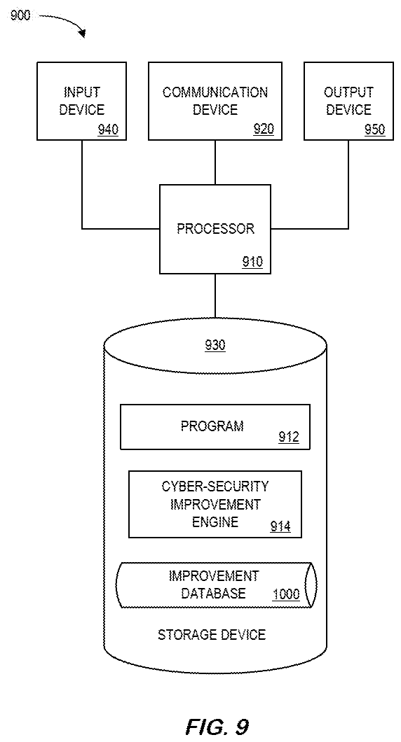

Embodiments described herein may comprise a tool to help provide cyber-security improvements and may be implemented using any number of different hardware configurations. For example, FIG. 9 illustrates a platform 900 that may be, for example, associated with the cyber-security improvement platforms 250, 450 of FIGS. 2 and 4, respectively (as well as other systems described herein). The platform 900 comprises a processor 910, such as one or more commercially available Central Processing Units (“CPUs”) in the form of one-chip microprocessors, coupled to a communication device 920 configured to communicate via a communication network (not shown in FIG. 9). The communication device 920 may be used to communicate, for example, with one or more remote platforms and/or a ledger. Note that communications exchanged via the communication device 920 may utilize security features, such as those between a public internet user and an internal network of an insurance enterprise. The security features might be associated with, for example, web servers, firewalls, and/or Public Key Infrastructure (“PKI”) devices. The platform 900 further includes an input device 940 (e.g., a mouse and/or keyboard to enter information about a distributed transaction ledger, a security flaw, etc.) and an output device 950 (e.g., to output usage reports, arrange for a transfer funds, etc.).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and a cyber-security improvement engine 914 for controlling the processor 910. The processor 910 performs instructions of the programs 912, 914, and thereby operates in accordance with any of the embodiments described herein. For example, the processor 910 may access electronic records including information, received from remote submitting devices, associated with vulnerability data for computing elements. For example, information associated with first vulnerability data for a first computing element may be retrieved from the database and verified. Information about the first vulnerability data may then be recorded by the processor 910 in a secure, distributed transaction ledger, and a crypto-currency payment may be transferred in connection with the recorded information. Similarly, the electronic records may further include fix data for computing elements. In this case, first fix data associated with the first vulnerability data may be retrieved by the processor 910, verified, and applied in connection with the first computing element. Additional information, about the first fix data, may then be recorded by the processor 910 in the transaction ledger and an additional crypto-currency payment may be transferred in connection with the recorded additional information.

The program 912 may be stored in a compressed, compiled, uncompiled and/or encrypted format. The program 912 may furthermore include other program elements, such as an operating system, a database management system, and/or device drivers used by the processor 910 to interface with peripheral devices.

As used herein, information may be “received” by or “transmitted” to, for example: (i) the platform 900 from another device; or (ii) a software application or module within the platform 900 from another software application, module, or any other source.

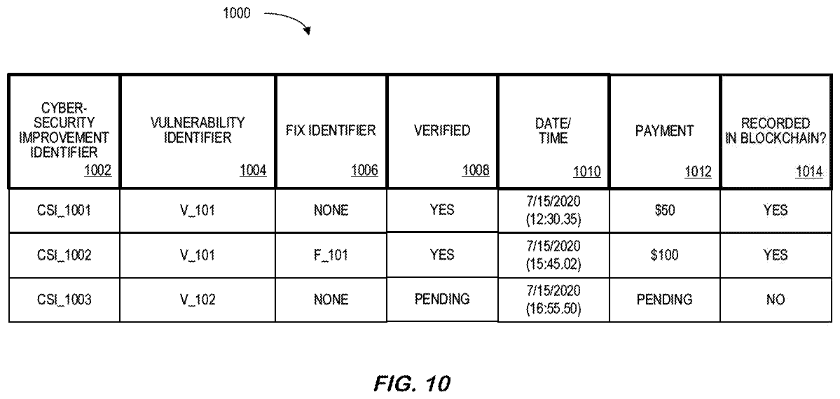

In some embodiments (such as shown in FIG. 9), the storage device 930 further stores an improvement database 1000. An example of a database that might be used in connection with the platform 900 will now be described in detail with respect to FIG. 10. Note that the database described herein is only an example, and additional and/or different information may be stored therein. Moreover, various databases might be split or combined in accordance with any of the embodiments described herein. For example, the improvement database 1000 might be combined with and/or linked to the program 912.

Referring to FIG. 10, a table is shown that represents the improvement database 1000 that may be stored at the platform 900 in accordance with some embodiments. The table may include, for example, entries identifying cyber-security improvements for computing elements. The table may also define fields 1002, 1004, 1006, 1008, 1010, 1012, 1014 for each of the entries. The fields 1002, 1004, 1006, 1008, 1010, 1012, 1014 may, according to some embodiments, specify: a cyber-security improvement identifier 1002, a vulnerability identifier 1004, a fix identifier 1006, a verified indication 1008, a date and time 1010, a payment 1012, and an indication of whether or not the improvement was recorded via a blockchain transaction ledger 1014. The improvement database 1000 may be created and updated, for example, based on information electrically received from remote submitting devices, distributed transaction ledger devices, etc.

The cyber-security improvement identifier 1002 may be, for example, a unique alphanumeric code identifying a specific vulnerability and/or fix that has been identified by the system (and might further include a computing element identifier). The vulnerability identifier 1004 might comprise a pointer or link to a description of a discovered software flaw. The fix identifier 1006 might include code, diagrams, protocol changes, etc. that correct the security flaw. The verified indication 1008 indicates whether a system (or person) was verified that the reported problem and/or solution do, in fact, exist. The date and time 1010 may indicate when the improvement was last updated, and the payment 1012 might indicate an amount of crypto-currency that the provided in exchange for the improvement (as well as who received the payment. The indication of whether or not the improvement was recorded via a blockchain transaction ledger 1014 might indicate that the improvement was recorded, is currently pending, etc.

Thus, embodiments may enable a decentralized verification and increase the number of investigators focused on cyber-security. Embodiments may also provide incentives for disclosure of such vulnerabilities and improve responsiveness. Further note that embodiments may provide a revenue stream for companies to secure all software (not just their own) and result in higher quality computing elements at a lower overall cost.

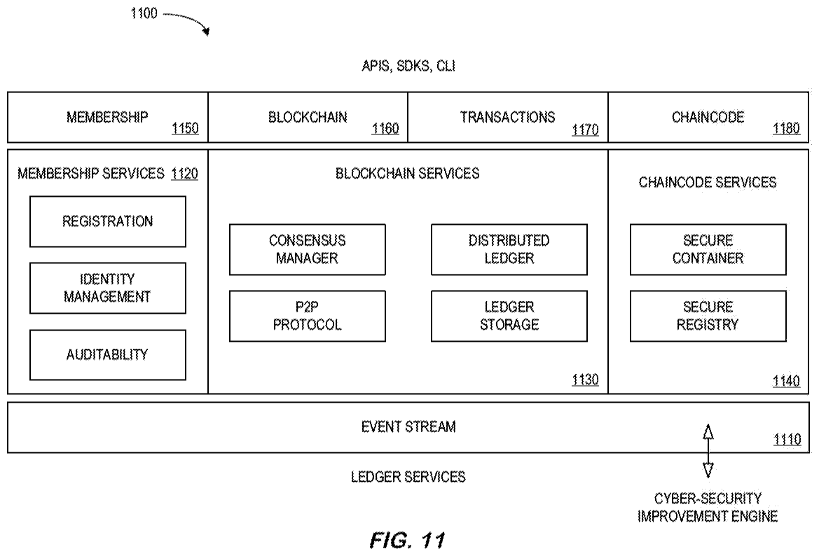

Embodiments may be associated with any type of distributed transaction ledger having a de-centralized consensus-based network, including those that support smart contracts, digital assets, record repositories, and/or cryptographic security. For example, FIG. 11 is a distributed transaction ledger reference architecture 1100 according to some embodiments. The architecture 1100 includes ledger services and an event stream 1110 that may contain network security service information (e.g., from a cyber-security improvement engine). Membership services 1120 (e.g., including registration, identity managements, and/or an auditability process) may manage identity, privacy, and confidentially for membership 1150 for the network security service. Blockchain services 1130 (e.g., including a consensus manager, Peer-to-Peer (“P2P”) protocol, a distributed transaction ledger, and/or ledger storage) may manage the distributed transaction ledger through a P2P protocol built on HTTP to maintain a single state that is replicated at many nodes to support blockchains 1160 and transactions 1170. Chaincode services 1140 (e.g., secure container and/or a secure registry associated with a smart contract) may help compartmentalize smart contract (or chaincode 1180) execution on validating nodes. Note that the environment may be a “locked down” and secured container with a set of signed base images that contain a secure OS and programming languages. Finally, APIs, Software Development Kits (“SDKs”), and/or a Command Line Interface (“CLI”) may be utilized to support a network security service via the reference architecture 1100.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

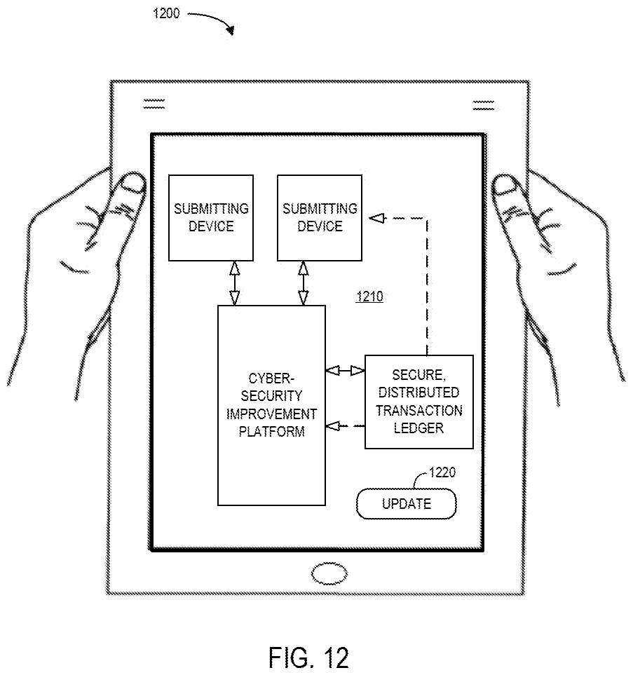

Note that the processes described herein might be applicable in other security improvement environments. For example, an improvement platform might improve physical security at an airport, jail, school, etc. Although specific hardware and data configurations have been described herein, note that any number of other configurations may be provided in accordance with embodiments of the present invention (e.g., some of the information described herein may be combined or stored in external systems). Moreover, although embodiments have been described with respect to transaction information processing system, note that embodiments might be associated with other types of processing systems in general. Similarly, the displays shown and described herein are provided only as examples, and other types of displays and display devices may support any of the embodiments. For example, FIG. 12 illustrates a tablet computer 1200 with a display 1210 that might utilize an interactive graphical user interface. The display 1210 might comprise a graphical overview of the devices associated with cyber-security improvements. Selection of an element on the display 1210 might result in further information about that element being presented (e.g., a current status of a computing element) and an update icon 1220 might be provided to refresh the information on the display 1210.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to facilitate cyber-security improvements using a secure, distributed transaction ledger, comprising:
a cyber-security improvement platform communication port to exchange information with a plurality of remote submitting devices via a distributed computer system;
a cyber-security improvement platform database storing electronic records including information, received from remote submitting devices, associated with vulnerability data for computing elements;
a cyber-security improvement platform computer processor, coupled to the cyber-security improvement platform communication port and the cyber-security improvement platform database, adapted to:
retrieve, from the cyber-security improvement platform database, information associated with first vulnerability data for a first computing element,
verify the first vulnerability data, and
record information about the first vulnerability data in the secure, distributed transaction ledger, wherein a crypto-currency payment is transferred in connection with the recorded information.

2. The system of claim 1, wherein the electronic records in the cyber-security improvement platform database further include information, received from remote submitting devices, associated with fix data for computing elements, and further wherein the cyber-security improvement platform computer processor is further adapted to:
retrieve, from the cyber-security improvement platform database, first fix data associated with the first vulnerability data,
verify the first fix data,
arrange for the first fix data to be applied in connection with the first computing element, and
record additional information about the first fix data in the secure, distributed transaction ledger, wherein an additional crypto-currency payment is transferred in connection with the recorded additional information.

3. The system of claim 2, wherein the first computing element is associated with at least one of: (i) a software element, (ii) a hardware element, and (iii) a network element.

4. The system of claim 2, wherein the secure, distributed transaction ledger comprises blockchain technology.

5. The system of claim 4, wherein the blockchain ledger is: (i) controlled by a single, centralized entity, or (ii) controlled by multiple, distributed entities.

7. The system of claim 2, wherein a cyber-security improvement platform entity also receives a crypto-currency payment.

8. The system of claim 2, wherein the information recorded in the secure, distributed transaction ledger represents a proof of work algorithm.

9. The system of claim 2, wherein the cyber-security improvement platform computer processor is further adapted to perform at least one of the following: (i) a duplicate vulnerability data check, and (ii) a duplicate fix data check.

10. The system of claim 2, wherein the cyber-security improvement platform computer processor automatically verifies the first fix data.

11. The system of claim 2, wherein the cyber-security improvement platform computer processor uses human assistance to verify the first fix data.

12. The system of claim 11, wherein the human assistance includes the consensus of a plurality of humans.

13. The system of claim 11, wherein cyber-security improvement platform computer processor also uses human assistance to verify the first vulnerability data.

14. A computer-implemented method to facilitate cyber-security improvements using a secure, distributed transaction ledger, comprising:
retrieving, by a cyber-security improvement platform computer processor, information associated with first vulnerability data for a first computing element from a cyber-security improvement platform database, wherein the cyber-security improvement platform database stores electronic records including information, received from remote submitting devices, associated with vulnerability data for computing elements;
verifying the first vulnerability data; and
recording information about the first vulnerability data in the secure, distributed transaction ledger, wherein a crypto-currency payment is transferred in connection with the recorded information.

15. The method of claim 14, wherein the electronic records in the cyber-security improvement platform database further include information, received from remote submitting devices, associated with fix data for computing elements, and further comprising:
retrieving, from the cyber-security improvement platform database, first fix data associated with the first vulnerability data;
verifying the first fix data;
arranging for the first fix data to be applied in connection with the first computing element; and
recording additional information about the first fix data in the secure, distributed transaction ledger, wherein an additional crypto-currency payment is transferred in connection with the recorded additional information.

16. The method of claim 15, wherein the first computing element is associated with at least one of: (i) a software element, (ii) a hardware element, and (iii) a network element.

17. The method of claim 15, wherein the secure, distributed transaction ledger comprises blockchain technology.

18. The method of claim 17, wherein the blockchain ledger is: (i) controlled by a single, centralized entity, or (ii) controlled by multiple, distributed entities.

19. The method of claim 15, wherein a cyber-security improvement platform entity also receives a crypto-currency payment.

20. A non-transitory, computer-readable medium storing instructions that, when executed by a computer processor, causes the computer processor to perform a method to facilitate cyber-security improvements using a secure, distributed transaction ledger, the method comprising:
retrieving, from a cyber-security improvement platform database, first fix data associated with a first computing element, wherein the cyber-security improvement platform database stores electronic records including information, received from remote submitting devices, associated with fix data for computing elements;
verifying the first fix data;
arranging for the first fix data to be applied in connection with the first computing element; and
recording information about the first fix data in the secure, distributed transaction ledger, wherein a crypto-currency payment is transferred in connection with the recorded information.

21. The medium of claim 20, wherein the electronic records in the cyber-security improvement platform database further include information, received from remote submitting devices, associated with vulnerability data for computing elements, and the method further comprises:
retrieving, by the cyber-security improvement platform computer processor, information associated with first vulnerability data associated with the first fix data from the cyber-security improvement platform database;
verifying the first vulnerability data; and
recording additional information about the first vulnerability data in the secure, distributed transaction ledger, wherein an additional crypto-currency payment is transferred in connection with the recorded additional information.
